(19) United States
(12) Patent Application Publication
(10) Pub. No.: US 2013/0192680 A1
(43) Pub. Date: Aug. 1, 2013

(54) DEVICE AND METHOD FOR MEASURING THE FILLING LEVEL

(71) Applicants: Frank Dziobek, Muehlheim/Ruhr (DE); Joachim Johanning, Oberhausen (DE)

(72) Inventors: Frank Dziobek, Muehlheim/Ruhr (DE); Joachim Johanning, Oberhausen (DE)

(73) Assignee: THYSSENKRUPP UHDE GMBH, Dortmund (DE)

(21) Appl. No.: 13/580,124

(22) PCT Filed: Feb. 17, 2011
(86) PCT No.: PCT/EP11/00753

§ 371 Date: Oct. 16, 2012

(30) Foreign Application Priority Data
Feb. 22, 2010 (DE) 10 2010 008 843.9

(51) Int. Cl. G05D 9/00

(52) U.S. Cl. CPC G05D 9/00
USPC 137/2; 137/386

(57) ABSTRACT

A measurement device for regulating the filling level of a liquid-gas mixture via a inlet valve in a container, having at least one vertical liquid standpipe fixed to a outer wall of the container and fluidically connected to the interior of the container via horizontal tube-shaped hydraulic devices. A first lower hydraulic device is disposed near the container base so the standpipe level changes with the container. A second hydraulic device is provided above the desired filling level so that the standpipe level changes when a selectable desired filling level value is exceeded. The device has a display and regulator that is in controlled connection to the liquid inlet valve. The liquid standpipe has a third tube-shaped hydraulic device that protrudes horizontally into the container and is arranged in the container at or below the desired filling level. The first lower hydraulic device is configured as a return.

The invention relates to a new measuring device and to a process, as well as to its application as a level control in vessels with liquid-gas mixtures. It is conceivable that the invention can also be used in steam drums and generally in separators for two-phase mixtures, as well as in evaporators.

From prior art level gauges are known which are executed as standpipes arranged on the side of the respective vessels and equipped with sight glasses to observe the fluid levels in the vessels. The standpipes each have an upper and a lower level gauge connection, which are both connected with the internal chambers of the vessels in a fluid-conducting manner. The lower level gauge connections are installed close to the bottom of the vessels and the upper level gauge connections are positioned considerably higher than the desired set points for the fluid levels.

Measurement is carried out on the principle of “communicating pipes”. The fluid standpipe displays the same level status as is demonstrated in the vessel as long as the liquid in the fluid standpipe and the liquid in the vessel have the same density rho. In the case of pure liquids this basic prerequisite for the liquid in the vessel and the liquid in the measuring pipe to have the same rho value is met with a good degree of accuracy and the measuring principle described can be applied without any difficulty.

However, in liquid-gas mixtures in a vessel, the density is dependent upon the amount of gas contained in the liquid. This means that the above-mentioned requirement is not always met when it comes to level measurements for vessels with two-phase mixtures because the two-phase mixture separates in the standpipe and the pure liquid has a corresponding higher density. Consequently there is a degree of uncertainty associated with this measurement. There are indeed operating conditions in which the rho of the liquid in the vessel is only half as great as the rho in the fluid standpipe. With evaporators the quantity of rising gas bubbles and, consequently, the reduction in the effective density is a function of the evaporator load; there is, therefore, no constant deviation in the specific weight between the two-phase mixture and the liquid. This means that the effective pressure on the lower level gauge connections is dependent upon the effective density of the medium in the evaporator chamber. This density is, however, reduced by the vapour bubble concentration of the evaporating medium to an extent which cannot be directly determined from outside.

Therefore, with evaporators the extent to which the effective density of the medium in the evaporator chambers is reduced fundamentally depends on the amount of liquid evaporating, i.e. on the evaporator load. For this reason it is possible that the fill level in the evaporator chamber will rise up to the droplet separator although the fill level displayed suggests that the fill level is normal.

A optimal fill level is reached in evaporators when all heat exchanger tubes are covered with liquid and the evaporator can perform at full capacity. A higher fill level is neither necessary nor desirable as there is a risk that fluid will also leave the vessel with the gas. This, in turn, can lead to damage to the downstream machines.

In general this problem, which is demonstrated here using the example of an evaporator, is also known to occur in all other vessels with two-phase mixtures, such as steam drums. In this case, the aim generally is to have a set point at around the central filling level of the vessel to ensure that the separation into gas and liquid phases is as clean as possible.

As a rule it is undesirable when liquid from this type of vessel is entrained with the gas phase, as impurities, such as salts, can be discharged with it. This can lead to corrosion and erosion in the downstream plant sections. In plants with evaporators immediately downstream, as is the case in refrigerating plants in ammonia plants, for example, this can also lead to damage to the impellers.

From this it follows that the described measuring principle has limited application when two-phase mixtures occur. In this case, it is irrelevant whether a local optical display is employed, or a remote display using an electrical pressure sensor.

If one relies on the display in the measuring tube despite the described measuring inaccuracy, then operating this type of control loop to control the fill level of a vessel with a liquid-gas mixture requires a lot of experience and sensitivity. It is not possible to make an optimum adjustment to the fill level in the vessel to suit all conceivable load conditions.

This means that, depending on the construction and application or operation of the vessel, the optimum operating level is known, but the problem of how to measure this accurately still remains to be solved.

Therefore, the objective of the invention is to provide a measuring device, a process to operate this measuring device, as well as applications for this measuring device which, at a certain set point of the fill level in the vessel, make it possible to guarantee that the fluid level in the vessel does not rise to a level where liquid is discharged out of the vessel along with the gas phase.

This is achieved by means of a new measuring device for controlling the fill level of a liquid-gas mixture using a liquid feed valve in a vessel, comprising at least one vertical fluid standpipe which is installed on the side external wall of the vessel and which is connected in a fluid-bearing manner with the internal chamber of the vessel via horizontal, tube-like, hydraulic devices, wherein
a first lower level hydraulic device is installed close to the bottom of the vessel so that the fill level in the fluid standpipe changes with that in the vessel, and
a second hydraulic device is provided above the set point of the fill level in the vessel so that the fill level in the fluid standpipe changes when the set point for the fill level in the vessel, which can be freely selected, is exceeded, and
the measuring device is equipped with a display and control unit which has a controlling connection with the liquid feed valve of the vessel, and
the vessel includes inlet and outlet lines for liquids and gases, and
the fluid standpipe is equipped with at least a further third tube-like hydraulic device which protrudes into the vessel horizontally, which is installed at the height of the set point or below the set point of the fill level in the vessel, and
the first lower level hydraulic device, in relation to the other hydraulic devices provided, is designed to throttle the reflux flow.

In so doing, the expression “at the height of the set point of the fill level in the vessel” means installing the third tube-like hydraulic device which protrudes into the vessel horizontally, and which corresponds directly to the set point measured at the centre point of the tube-like hydraulic device.

Installing this third hydraulic device below the set point guarantees that, upon reaching the set point in the vessel, in addition to the fluid level in the fluid standpipe being displayed, the corresponding value will also be displayed in the fluid standpipe. In a preferred embodiment of the invention the third tube-like hydraulic device, which protrudes into the vessel horizontally, measured at the centre point of the diameter of the hydraulic device, is installed at 1 to 25% in relation to the set point, with preference being given to 1 to 15%, and particular preference being given to 8 to 12% below the set point.

In a preferred embodiment of the invention the vessel is an evaporator wherein the set point of the fill level in the evaporator is achieved by means of complete coverage of the heating unit contained in the evaporator. In so doing the heating units in the evaporator comprise at least one heat exchanger tube. The liquid can, for example, be any cooling liquid known from prior art.

In a further embodiment of the invention the vessel is a steam drum, wherein the set point of the fill level in the steam drum is achieved at a central fill level, wherein deviations of 0-20%, with preference given to 0-10%, and particular preference given to 0-5% of the central fluid level in the steam drum are permitted.

The reflux-flow-throttling embodiment of the first hydraulic device preferably comprises one of the methods: Profile-restricting devices and/or valves and/or reflux throttles.

It is advantageous for the tube-like hydraulic devices to be selected from the nozzles and tubes group.

It is advisable for the display and control device to be fitted with sensors and/or probes.

The corresponding process for controlling the fill level of a liquid-gas mixture in a vessel by means of the measuring device described comprises the following process steps:
a liquid is fed into the vessel, wherein the liquid streams into the fluid standpipe fixed to the outside of the vessel through a first hydraulic device which is installed close to the bottom of the vessel and, in relation to the other hydraulic devices provided, is designed to throttle the reflux flow, and
upon the fill level rising further in the vessel and the corresponding level being reached the liquid is fed through at least one additional third hydraulic device which is installed at the height of the set point or below the set point of the fill level of the vessel, and the liquid in the fluid standpipe is filled up to the actual level, and
upon additional liquid being fed into the vessel the level of the liquid in the fluid standpipe is filled up further, and
any gas escaping from the liquid in the external fluid standpipe is fed via a second hydraulic device which is installed above the set point of the fill level in the vessel, and
upon reaching the set point the liquid feed into the vessel is halted by means of a display device in the fluid standpipe sending a signal to a control device which causes the liquid reflux valve of the vessel to close, and
in the event of the set point not being reached a signal is sent by the display and control device, whereby the liquid reflux valve of the vessel is opened.

In a further embodiment of the process a liquid is fed into the vessel, which is an evaporator, and this liquid is heated in the evaporator via heating units and is discharged from the evaporator as gas.

In a further possible embodiment of the invention a liquid, which is enriched with gas bubbles, is fed into the vessel, which is a steam drum, and this liquid is separated from the gas bubbles in the steam drum, and gas and liquid are discharged from the steam drum in separate streams.

A preferred application sees the measuring device used for controlling the fill level in cold evaporators with two-phase mixtures. This application is particularly advantageous for ammonia plants. It can also be used in hot evaporators.

A further possible application is to use the measuring device to control the fill level in steam drums in which a water/steam mixture is separated.

The following diagrams are used to describe the different design variants of the invention in more detail:

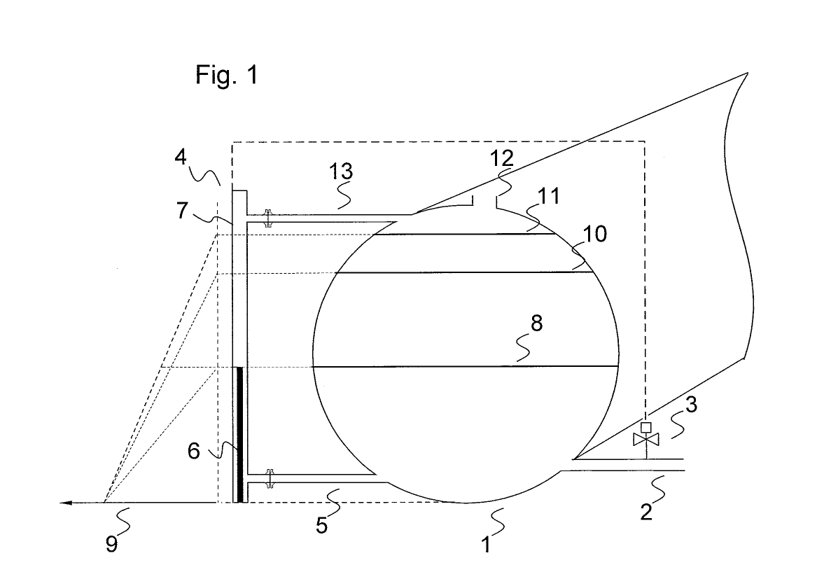

FIG. 1: A schematic representation of a measuring device according to prior art for controlling the fill level of a liquid-gas mixture is shown by means of a cross section of a vessel.

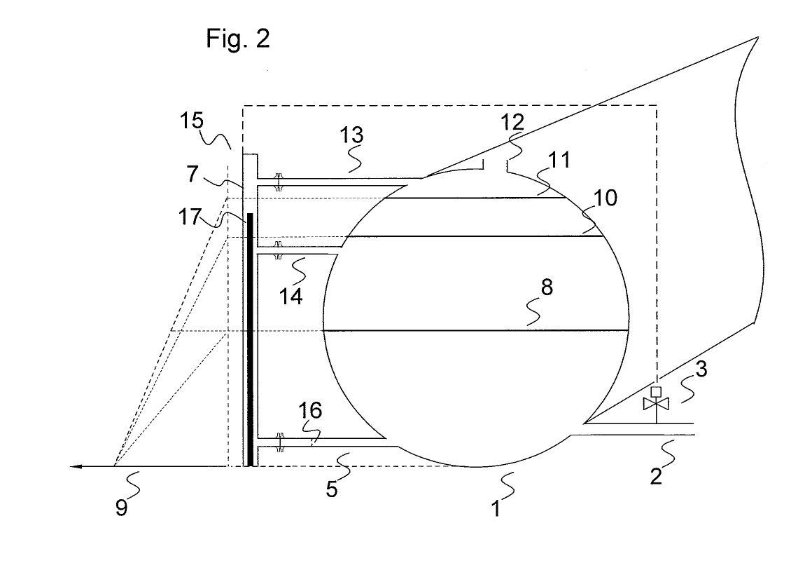

FIG. 2: A schematic representation of the measuring device in accordance with the invention for controlling the fill level of a liquid-gas mixture is shown by means of a cross section of a vessel.

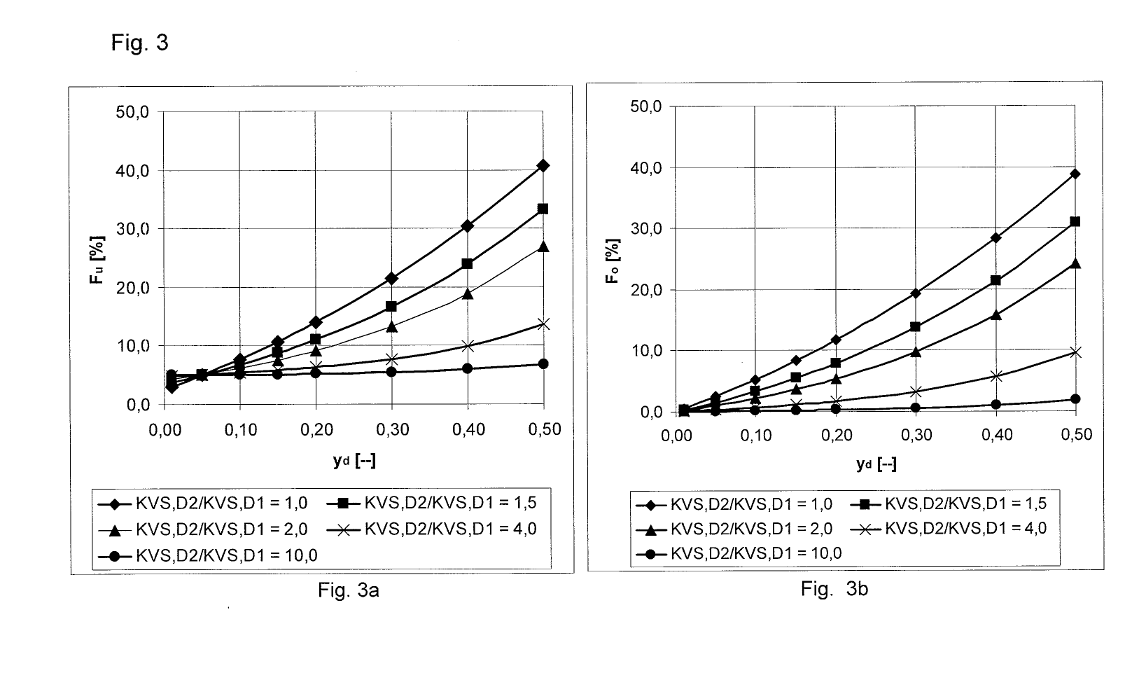

FIG. 3: Representation of the measuring error to be expected for the liquid level using the device according to the invention.

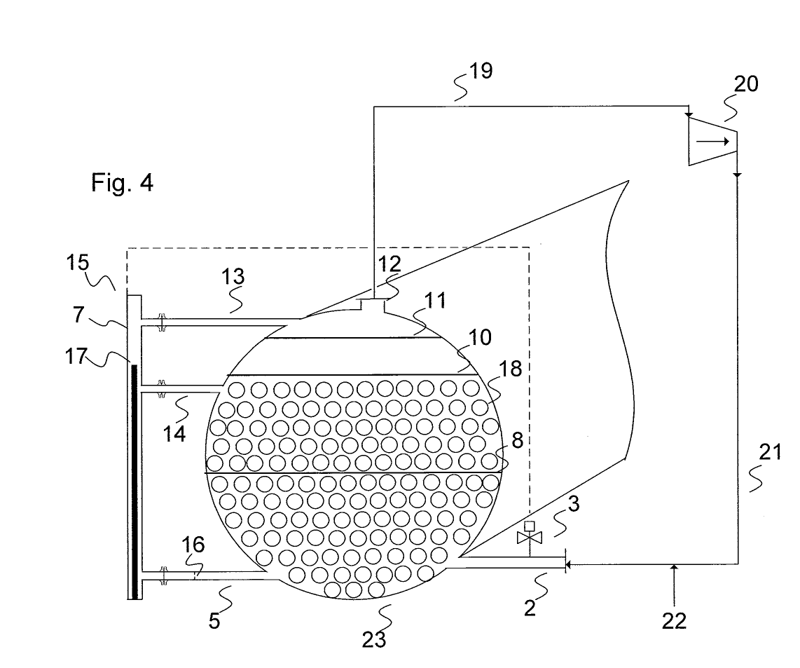

FIG. 4: A schematic representation of the measuring device according to the invention for the fill level of a liquid-gas mixture is shown using a cross section of a shell and tube cold evaporator.

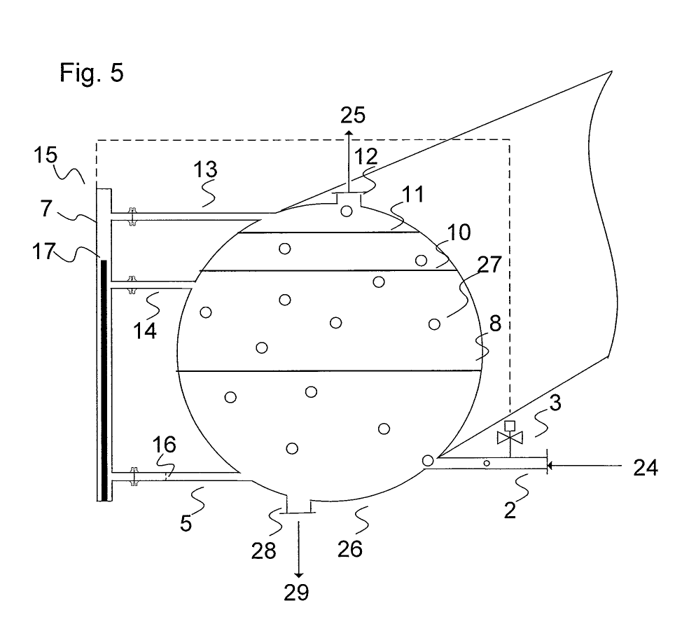

FIG. 5: A schematic representation of the measuring device according to the invention for the fill level of a water-steam mixture is shown using a cross section of a steam drum.

FIG. 1 shows a vessel 1 which has a feed line 2, which is fitted with a controllable liquid feed valve 3 which has a controlling connection to the measuring device according to prior art 4 Should liquid end up in vessel 1, this liquid flows into the first lower level gauge connection 5 of the measuring device according to prior art 4 which is installed close to the bottom of the vessel. As the fill level in vessel 1 rises, the liquid column 6 in the fluid standpipe 7 of the measuring device according to prior art 4 also rises. The liquid column 6 in the fluid standpipe 7 rises up to the stoppage value 8 of the liquid.

Should the liquid contain gas bubbles, the displayed liquid level 6 in the fluid standpipe 7 subsequently has an error which occurs a result of the effective static pressure 9 on the first lower level gauge connection 5 being dependent upon the effective density of the medium in the inside of the vessel. This density is reduced by the gas bubble concentration of the liquid in the vessel. In a measuring device according to prior art gas and liquid separate in the outer fluid standpipe 7, the gas is discharged via the second upper level gauge connection 13 which is provided above the set point 10 in the vessel 1, and the liquid column 6 only comprises liquid with the corresponding higher density. As there is pressure equilibrium in the lower level gauge connection 5, the height of the liquid column 6 is, in principle, lower than in the vessel.

For this reason it is possible for the actual value 11 of the liquid height in the inside of the vessel to already be higher than the liquid column 6 in the fluid standpipe. If y_{d} is the mean steam content of the liquid in the vessel, the formula

Fₕ=(h_{b}−hₘ)/h_{b}=1−h_{b}/hₘ=y_{d}

for the relative error of the conventional measuring device can be derived from the equilibrium of the hydrostatic pressures in the lower level gauge connection 5 The error is fundamentally dependent upon the volumetric gas content of the liquid and is largely constant across the entire measurement range. In the formula h_{b} represents the actual level (8) of the liquid level in the vessel and hₘ represents the measured value (6) in accordance with FIG. 1.

For this reason it is very difficult to maintain a desired set point 10 for a two-phase mixture in the inside of the vessel by means of the measuring device 4 and to prevent liquid from being discharged from the vessel 1 via a gas discharge nozzle 12.

Late identification of the actual liquid level in the vessel 1 is very disadvantageous as it can eventually lead to liquid being discharged via the gas phase which is discharged from the vessel 1 via the gas discharge nozzle 12.

In FIG. 2 , which shows the vessel 1 with the measuring device according to the invention 15, when liquid flows in, liquid also then flows via the first lower level gauge connection 5 of the measuring device 15 into the fluid standpipe 7. In so doing, the liquid column in the fluid standpipe rises up to the stoppage value 8 of the liquid. This corresponds to the same value as the liquid column 6 from FIG. 1.

Should the liquid contain gas bubbles, the displayed liquid level in the fluid standpipe 7 has the same error as that represented in the description in FIG. 1 even with the measuring device according to the invention 15. Should the liquid level in the vessel 1 rise even further, the liquid is fed via an additional gauge connection 14, which is installed beneath the set point 10 of the fill level of vessel 1. The liquid column 6 from FIG. 1 in the fluid standpipe 7 is thereby filled up to the actual level. A driving force now occurs in the fluid standpipe 7 as the static pressure 9 at the foot of the fluid standpipe 7 is higher than the static pressure at the bottom of the vessel. This is due to the fact that when the fill level in vessel 1 is the same height a two-phase mixture takes effect, whilst pure liquid is present in the fluid standpipe 7. This causes a loop flow to be started in the fluid standpipe 7 and the liquid in fluid standpipe 7 flows through the first lower level gauge connection 5 back into the vessel 1. In the case of the measuring device according to the invention 15 this reflux is arrested via a reflux flow throttle 16, so that the liquid cannot escape from the fluid standpipe more quickly than liquid runs through the additional gauge connection. For this reason the measurement at this operating point is very exact and almost corresponds to the set point 10. This measuring error is addressed in the following description relating to FIG. 3.

However, as the set point for this operating point has not yet been fully achieved, the feed valve 3 remains open, and the liquid column 17 in the fluid standpipe 7 continues to rise. Gas escaping from the liquid in the fluid standpipe 7 leaves the fluid standpipe 7 via the second upper level gauge connection 13 which is provided above the set point 10 in the vessel 1. Upon the set point being reached the liquid is stopped from being fed into the vessel 1 by means of a signal being sent via sensors to the controllable liquid feed valve 3, and the liquid feed valve 3 is closed.

Should the liquid in the vessel 1 continue to rise, this liquid flows via the upper level gauge connection 13 into the fluid standpipe 7, wherein the liquid column 17 in the fluid standpipe 7 is filled up further and an excess value is displayed. Upon the excess value being reached a new signal is sent to the controllable liquid feed valve 3 via sensors, wherein the liquid feed valve 3 then closes and consequently no further liquid can get into the vessel 1.

Only when the set point 10 has been exceeded is a new signal transmitted to the liquid feed valve 3 which causes the liquid feed valve 3 to open again and liquid to stream back into the vessel 1 again.

The measurement error to be expected of the device according to the invention is described in detail below using FIG. 3. If—as shown in FIG. 2—the volumetric steam content of the liquid in the vessel is identified as y_{d}, the liquid level in the vessel as h_{b}, the liquid level in the new measuring device as hₘ, the height of the third feed valve 14 as H, as well as the flow rate coefficients of the lower level gauge connection as K_{vs,D1} and that of the feed valve 14 as K_{VS,D2}, this results in the correlation between the actual liquid level in the vessel h_{b} and the displayed measurement value hₘ for the case

hₘ<H

to

h_{b}=hₘ^{*}[1+H/hₘ^{*}(1−y_{d})^{2*}(K_{VS,D2}/K_{VS,D1})²]/[(1−y_{d})+(1−y_{d})^{2*}(K_{VS,D2}/K_{VS,D1})²]

and the relative error between actual value and measured value 6

Fᵤ=(h_{b}−hₘ)/h_{b}=1−hₘ/h_{b}

Fᵤ1−[(1−y_{d})+(1−y_{d})^{2*}(,K_{VS,D2}/K_{VS,D1})²]/[1+H/hₘ^{*}(1−y_{d})^{2*}(K_{VS,D2}/K_{VS,D1})²]

as well as for the case

hₘ≧H

the correlation between the actual liquid level in the vessel h_{b} and the displayed measured value hₘ to

h_{b}=hₘ^{*}[y_{d}*H/hₘ+(1−y_{d})+(1−y_{d})^{2*}(K_{VS,D2}/K_{VS,D1})^{2]/[(}1−y_{d})+(1−y_{d})^{2*}(K_{VS,D2}/K_{VS,D1})²]

and the relative error between actual value and measured value to

Fₒ=[(1−y_{d})+(1−y_{d})^{2*}(K_{VS,D2}/K_{VS,D1})²][y_{d}^{*}H/hₘ+(1−y_{d})+(1−y_{d})^{2*}(K_{VS,D2}/K_{VS,D1})²]

FIG. 3 shows how the residual error with the new measuring device is dependent upon the selection of the flow properties of the lower level gauge connection 5 (K_{VS,D1}), as well as the additional third gauge connection 14 (K_{VS,D2}), and illustrates the extremely slight extent of the residual error, even for high levels of steam content y_{d} in the liquid, when the appropriate correlation K_{VS,D2}/K_{VS,D1} is selected. In this connection FIG. 3a shows the errors in the range hₘ<H and FIG. 3b shows the errors for the range hₘ≧H.

FIG. 4 shows the application of the measuring device according to the invention using a cold evaporator 23, as is used, for example, in ammonia plants. It can also be started with an empty cold evaporator 23, if this is procedurally possible As soon as liquid cooling agent 21,22 enters the first lower level gauge connection 5, the measuring device, as described below in Fig.2, begins its work. In this application the set point 10 is achieved by completely covering the heat exchanger tubes 18 with cooling agent 21, 22. As a result of the heat exchanger tubes 18 contained in the cold evaporator the liquid cooling agent 21, 22, which is in the cold evaporator 23, evaporates and forms rising gas bubbles in the liquid as a result of which a two-phase mixture occurs. These gas bubbles leave the cold evaporator 23 via the gas discharge valve 12. The gaseous cooling agent is fed via a pipeline 19 into an evaporator 20 with the help of which the gaseous cooling agent is reliquefied and is fed back to the cold evaporator 23, whereby the cooling circuit closes. External cooling agent can be topped up via pipeline 22. As a preference in this application ammonia is used as the cooling agent.

When changing the cold evaporator 23 operation from full load to light load, the conditions are such that when the cold evaporator 23 is in light-load operation there are fewer gas bubbles in the liquid as less liquid evaporates. Thus the volume of the two-phase mixture is reduced by this amount. The consequence of this is that the fill level in the cold evaporator 23 drops sharply. The control process described in FIG. 2 now begins and the set point 10 of the fill level is brought to the optimum level again.

If the cold evaporator 23 should undergo a converse load shift from light-load operation to full-load operation, there is a risk that the cold evaporator 23 could overflow if there is a spontaneous change. The reason for this lies in the fact that the fill level in the cold evaporator 23 is located at the optimum point for a light-load operation, in which liquid cooling agent, as described above, is readjusted as a result of the low level of gas bubbles arising. If the gas bubble concentration spontaneously increases due to the cold evaporator 23 suddenly going into full-load operation, the volume of the fill level in the cold evaporator 23 also increases. This means that the gradient of the load change may not exceed the chamber volume of the cold evaporator 23. If this requirement is met, the fill level which is too high will be reduced by means of evaporation, whilst the controllable feed valve 3 remains closed until the optimum fill level, i.e. the set point 10, is reached again and the measuring device resumes its regular operation as described in FIG. 2.

FIG. 5 shows the application of the measuring device in accordance with the invention using a steam drum 26. In addition a water-steam mixture 24 is fed into the steam drum 26 via the feed pipeline 2. As soon as the water-steam mixture 24 gets into the first lower level gauge connection 5 the measuring device, as described in FIG. 2, starts its work. In this application, the set point 10 is, as the experts know, achieved when the fill level for the steam drum is approximately central. In the steam drum 26 the liquid separates from the rising vapour bubbles 27 and the steam 25 is discharged via the gas discharge valve. The liquid 29 released is discharged from the steam drum 26 via a liquid discharge valve 28.

The advantages arising from the invention are as follows:
can be achieved without great expense
an optimum fill level is achieved in the vessel at all times
the optimum fill level is also guaranteed in the event of load changes in evaporators
once the fill level in the vessel of the additional third hydraulic device of the measuring device has been achieved, the error of the optical display in the liquid measuring glass is only encumbered with a very slight error

### LIST OF REFERENCE NUMBERS AND DESIGNATIONS

1 Vessel

2 Feed line

3 Controllable fluid feed valve

4 Measuring device according to prior art

5 First lower level gauge connection

6 Liquid column

7 Liquid standpipe

8 Stoppage value

9 Static pressure

10 Set point

11 Actual value

12 Gas discharge nozzle

13 Second upper level gauge connection

14 Additional gauge connection

15 Measuring device according to the invention

16 Reflux flow throttle

17 Liquid column

18 Heat exchanger tubes

19 Pipeline

20 Evaporator

21 Liquid cooling agent

22 Liquid cooling agent

23 Cold evaporator

24 Water-steam mixture

1. A measuring device for controlling the fill level of a liquid-gas mixture using a liquid feed valve in a vessel, comprising at least one vertical fluid standpipe which is installed on the side external wall of the vessel and which is connected in a fluid-bearing manner with the internal chamber of the vessel via horizontal, tube-like, hydraulic devices, wherein
a first lower level hydraulic device is installed close to the bottom of the vessel so that the fill level in the fluid standpipe changes with that in the vessel, and
a second hydraulic device is provided above the set point of the fill level in the vessel so that the fill level in the fluid standpipe changes when the set point for the fill level in the vessel, which can be freely selected, is exceeded, and
the measuring device is equipped with a display and control unit which has a controlling connection with the liquid feed valve of the vessel, and the vessel includes inlet and outlet lines for liquids and gases
wherein
the fluid standpipe is equipped with at least a further third tube-like hydraulic device which protrudes into the vessel horizontally, which is installed at the height of
the set point or below the set point of the fill level in the vessel, and the first lower level hydraulic device, in relation to the other hydraulic devices provided, is designed to throttle the reflux flow.

2. The measuring device for controlling the fill level according to claim 1, wherein the vessel is an evaporator wherein the set point of the fill level in the evaporator is achieved by complete coverage of the heating unit contained in the evaporator.

3. The measuring device for controlling the fill level according to claim 2, wherein the heating units in the evaporator comprise at least one heat exchanger tube.

4. The measuring device for controlling the fill level according to claim 1, wherein the vessel is a steam drum, wherein the set point of the fill level in the steam drum is given with a central fill level, wherein deviations of 0-20%, with preference given to 0-10%, and particular preference given to 0-5% of the central fluid level in the steam drum are permitted.

5. The measuring device for controlling the fill level according to claim 1, wherein the third tube-like hydraulic device, which protrudes into the vessel horizontally, measured at the centre point of the diameter of the hydraulic device, is installed at 1 to 25% in relation to the set point, with preference being given to 1 to 15%, and particular preference being given to 8 to 12% below the set point.

6. The measuring device for controlling the fill level according to claim 1, wherein the reflux-flow-throttling embodiment of the first hydraulic device comprises one of the methods: Profile-restricting devices and/or valves and/or reflux throttles.

7. The measuring device for controlling the fill level according to claim 1, wherein the tube-like hydraulic devices are selected from the nozzles and tubes group.

8. The measuring device for controlling the fill level according to claim 1, wherein the display and control device are fitted with sensors and/or probes.

9. A process for controlling the fill level of a liquid-gas mixture in a vessel according to claim 1, wherein
a liquid is fed into the vessel, wherein the liquid streams into the fluid standpipe fixed to the outside of the vessel through a first hydraulic device which is installed close to the bottom of the vessel and, in relation to the other hydraulic devices provided, is designed to throttle the reflux flow, and
upon the fill level rising further in the vessel the liquid is fed through at least one additional third hydraulic device which is installed at the height of the set point or below the set point of the fill level of the vessel, and the liquid in the fluid standpipe is filled up to the actual level, and
upon additional liquid being fed into the vessel the level of the liquid in the fluid standpipe is filled up further, and
any gas escaping from the liquid in the fluid standpipe is fed via a second hydraulic device which is installed above the set point of the fill level in the vessel, and
upon reaching the set point the liquid feed into the vessel is halted by means of a display and control device in the fluid standpipe sending a signal which causes the liquid reflux valve of the vessel to close, and
in the event of the set point not being reached a signal is sent by the display and control device, whereby the liquid reflux valve of the vessel is opened.

10. The process according to claim 9 wherein a liquid is fed into the vessel, which is an evaporator, and this liquid is heated in the evaporator via heating units and is discharged from the evaporator as gas.

11. The process according to claim 9 wherein a liquid, which is enriched with gas bubbles, is fed into the vessel, which is a steam drum, and this liquid is separated from the gas bubbles in the steam drum, and gas and liquid are discharged from the steam drum in separate streams.

12. The measuring device according to claim 1 wherein the measuring device for controlling the fill level is used in cold evaporators with two-phase mixtures.

13. The measuring device according to claim 1 wherein the measuring device for controlling the fill level is used in cold evaporators in ammonia plants.

14. The measuring device according to claim 1 wherein the measuring device for controlling the fill level is used in steam drums in which a water/steam mixture is separated.
